(19) United States
(12) Patent Application Publication
(10) Pub. No.: US 2014/0070154 A1
(43) Pub. Date: Mar. 13, 2014

(54) SHEAVE BLOCK

(71) Applicants: Thiha Win, Auckland (NZ); Simone De Mari, Auckland (NZ)

(72) Inventors: Thiha Win, Auckland (NZ); Simone De Mari, Auckland (NZ)

(73) Assignee: Winmar Racing Ltd, Auckland (NZ)

(21) Appl. No.: 14/005,888

(22) PCT Filed: Mar. 16, 2012
(86) PCT No.: PCT/IB12/51283

§ 371 Date: Nov. 26, 2013

(30) Foreign Application Priority Data
Mar. 18, 2011 (IT) TO2011A000240

(51) Int. Cl. B66D 3/04

(52) U.S. Cl. CPC B66D 3/04
USPC 254/416

(57) ABSTRACT

A sheave block includes an internal ring, an external pulley wheel, which turns coaxially on the internal ring, rolling means set between the ring and the pulley wheel, and means of mutual axial retention of the ring and of the pulley wheel. The means of mutual axial retention have mutually facing integral races of the ring and of the pulley wheel in radial-axial contact with the rolling means. The internal ring has at least one angular area of localized increase of the radial distance between the integral races, where there is applied an insert for restoring said radial distance.

### CROSS REFERENCE TO RELATED APPLICATIONS

This application is a 371 National Phase of PCT International Application No. PCT/IB2012/051283 filed on Mar. 16, 2012, and published in English as WO 2012/127394 A1 on Sep. 27, 2012, which claims priority to Italian Patent Application No. TO2011A000240 filed on Mar. 18, 2011, the entire disclosures of which are incorporated herein by reference.

### FIELD OF THE INVENTION

The present invention relates in general to pulleys of the type comprising an internal ring, an external pulley wheel that turns coaxially on the internal ring, and rolling means set between the ring and the pulley wheel.

In particular, albeit not exclusively, the invention regards pulleys of this sort designed for use as sheave blocks on board watercraft, for running sheets or ropes subjected to heavy loads in restricted spaces. Fundamental requisites for said sheave blocks consist of a structure that is particularly sturdy but at the same time light and of limited overall dimensions.

### PRIOR ART

To be able to operate under the action of both radial and axial loads it is necessary to equip the sheave blocks with means of mutual axial retention between the internal ring and the external pulley wheel. Typically, said retention means consist of side plates or cheeks fixed to the sides of the internal ring, as in the case of the European patent application No. EP-0684408A1 Or else of annular flanges which are also applied to the opposite sides of the internal ring and delimit the race or races of the rolling means, as is for example illustrated in the U.S. Pat. No. 6,435,725.

The first solution entails risks of damage to the side plates or cheeks projecting from the sheave block both in the case of impact, which is anything but infrequent in particular on board racing clippers, and in the case where the pulley wheel over which the rope or sheet under load is run is not well aligned therewith. Possible damage to the side plates or cheeks can jeopardize proper operation of the sheave block.

With the second solution the production of the sheave block is relatively complicated and burdensome on account of the need to make the internal ring of a number of components that must be assembled together: a central part, lateral annular shoulders, and the corresponding retention flanges.

### SUMMARY OF THE INVENTION

The object of the present invention is to overcome the aforesaid drawbacks and to provide a sheave block of the type defined above that will eliminate the need for external auxiliary components for axial retention between the internal ring and the external pulley wheel and that, nevertheless, will present a structure that is appreciably sturdy and of reduced overall dimensions, as well as being relatively simple and inexpensive to produce.

With a view to achieving said object the sheave block according to the invention is mainly characterized in that the aforesaid means of axial retention are directly constituted by mutually facing integral races of the ring and of the pulley wheel in radial-axial contact with the rolling means, and in that the internal ring has at least one angular area of localized increase of the radial distance between the aforesaid integral races, where there is applied an insert for restoring said radial distance.

According to a first embodiment of the invention, the insert for restoring the radial distance consists of a body applied radially from inside the ring. In a variant, said insert consists of a double body axially applied on the outside of the ring, and in a further embodiment still it is constituted by a side ring axially applied to the pulley wheel.

In all the embodiments, the rolling means of the sheave block according to the invention can comprise at least one, and preferably two, annular series of balls or else of cylindrical rolls or else of conical rolls or else of cylindrical rolls with spherical heads, or combinations thereof, and possible corresponding cages.

In addition, the internal ring, the pulley wheel, and the insert for restoring the radial distance can be made of a single material or of a number of materials.

In a particularly advantageous embodiment of the invention, the sheave block comprises an internal body defining at least one inner race, an external pulley wheel that can turn coaxially on the internal body and defines at least one outer race facing said at least one inner race, rolling means set between said races, and means of mutual axial retention between the internal body and the pulley wheel. The means of mutual axial retention are directly constituted by said races in radial-axial contact with said rolling means, and the internal body has a radial interruption of the inner race or each inner race, set at which interruption is an insert for restoring the radial distance formed by two parts axially applied on opposite sides of said internal body.

Said two parts can consist of a pair of opposed symmetrical and interconnected sectors, the outer surfaces of which complete the aforesaid races, or else consist of a pair of elastic rings inserted within respective lateral annular grooves of the aforesaid body.

### BRIEF DESCRIPTION OF THE DRAWINGS

The invention will now be described in detail with reference to the annexed plate of drawings, which are provided purely by way of non-limiting example and in which:

FIG. 1 is a schematic cross-sectional view of a sheave block according to a first embodiment of the invention;

FIG. 2 is an exploded perspective view of the sheave block of FIG. 1;

FIG. 3 is a view similar to that of FIG. 1 that shows a second embodiment of the sheave block according to the invention;

FIG. 4 is an exploded perspective view of the sheave block of FIG. 3;

FIG. 5 is a perspective sectioned view and shows a third embodiment of the sheave block according to the invention;

FIG. 6 is an exploded perspective view of the sheave block of FIG. 5;

FIG. 7 is a view similar to those of FIGS. 1 and 3 that illustrates the sheave block according to the embodiment of FIGS. 5 and 6 provided with an innovative element for attachment to a strop;

FIG. 8 is a perspective view of the attachment element illustrated in FIG. 7; and

FIG. 9 shows schematically, in partial axial section, examples of possible rolling members that can be used in the sheave block according to the invention.

### DETAILED DESCRIPTION OF THE INVENTION

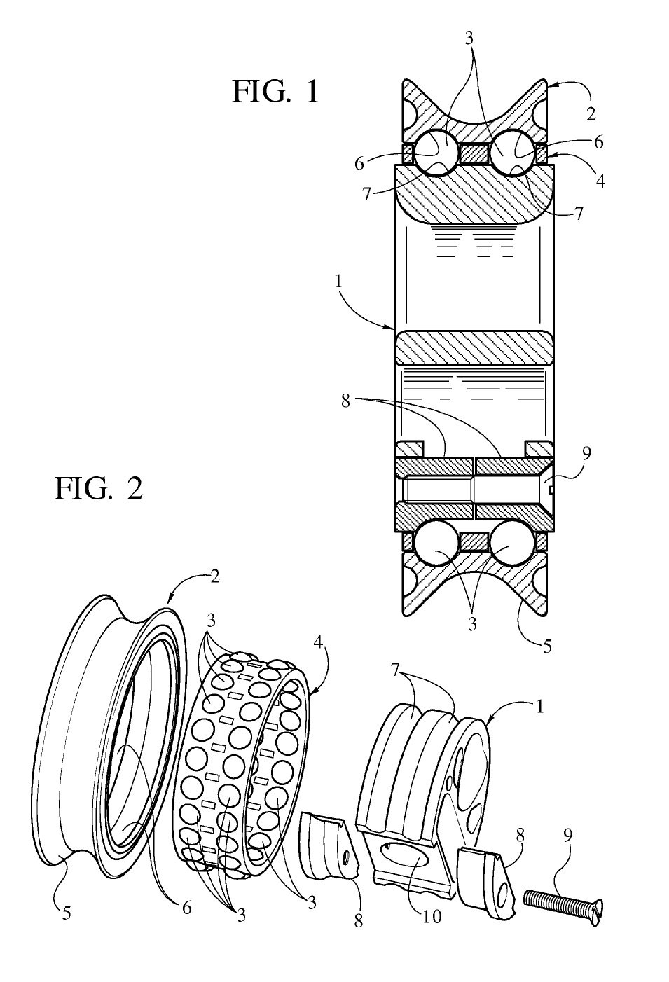

With initial reference to FIGS. 1. and 2, the sheave block according to a first embodiment of the invention comprises an internal ring 1, on which there turns coaxially a pulley wheel 2 with interposition of rolling members 3.

In this embodiment, as in the further embodiments that will be described hereinafter, the internal ring 1 and the pulley wheel 2, as well as the other components that will be described hereinafter, can be each made of a single piece, fur example a single piece of plastic material with high resistance, or else made of a number of materials and/or a number of parts rendered fixed with respect to one another during their production.

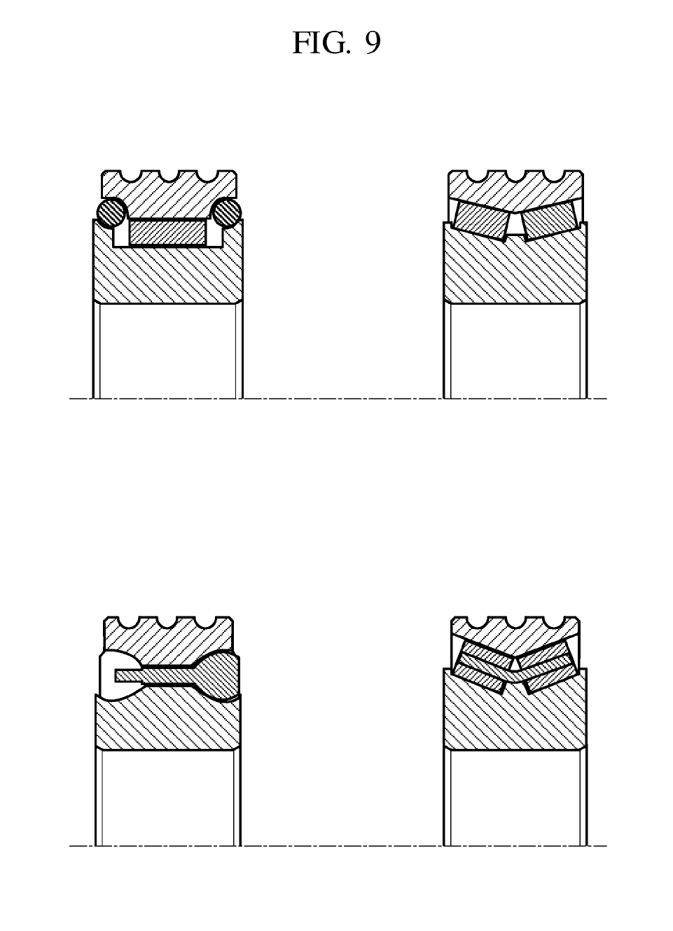

In the case of the example illustrated, the rolling members 3 are constituted by two annular series or rings of balls inserted within a common cage 4. It should be noted that in this as in the other embodiments described hereinafter the rolling members of the sheave block could be arranged according to a single annular series and could present a wide range of conformations, such as for example cylindrical rolls, conical rolls, cylindrical rolls with spherical heads, as briefly exemplified in FIG. 9, or combinations thereof. Any rolling body is in any case suitable for obtaining the sheave block according to the invention.

Also the corresponding cage 4, where envisaged, could present a combination different from the one illustrated, in one or more pieces.

The pulley wheel 2 is formed externally with an annular cavity or groove 5 designed to receive a sheet or the like, and internally with a pair of annular races 6 for the rolling members 3. Similar races 7, radially facing the races 6, are formed on the outer surface of the internal ring 1. According to the peculiar aspect of the invention, the races 6 and 7, formed integrally with the pulley wheel 2 and the ring 1, constitute themselves the means of mutual axial retention between the pulley wheel 2 and the ring 1, via the contact of radial-axial rolling of the rolling members 3. In other words, the sheave block according to the invention does not require, for said axial retention, typical state-of-the-art auxiliary members, such as external side plates or rings for axial containment.

The only additional element of the sheave block according to the invention, which is necessary for assembly of the rolling members 3 at the moment of its assemblage, consists of an insert that enables a localized increase of the radial distance between the races 6 and 7 and that, following upon insertion of the rolling members 3 between the ring 1 and the pulley wheel 2, enables said radial distance to be restored.

In the embodiment described with reference to FIGS. 1 and 2, the races 7 are interrupted at a missing radial portion 10 of the internal ring 1 and are completed by a pair of opposed and symmetrical sectors 8, applied axially on the outside of the ring 1. The two sectors 8, the outer surfaces of which complete the races 7, are interconnected by a screw 9 and define as a whole the insert for restoring the radial distance.

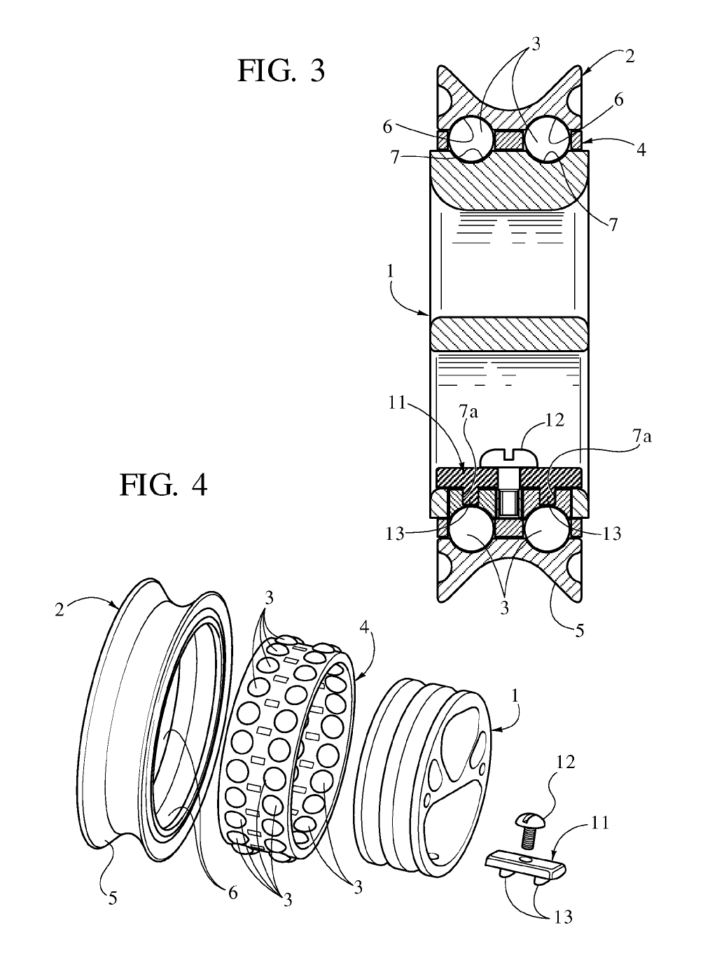

In the case of the variant represented in FIGS. 3 and 4, in which parts that are identical or similar to those already described previously are designated by the same reference numbers the insert for restoring the radial distance between the races 6 and 7 is constituted by a body 11 applied radially from inside the ring 1, fixed thereto via a screw 12 and provided with a pair of appendages 13 projecting radially within respective recesses 7a of the races 7.

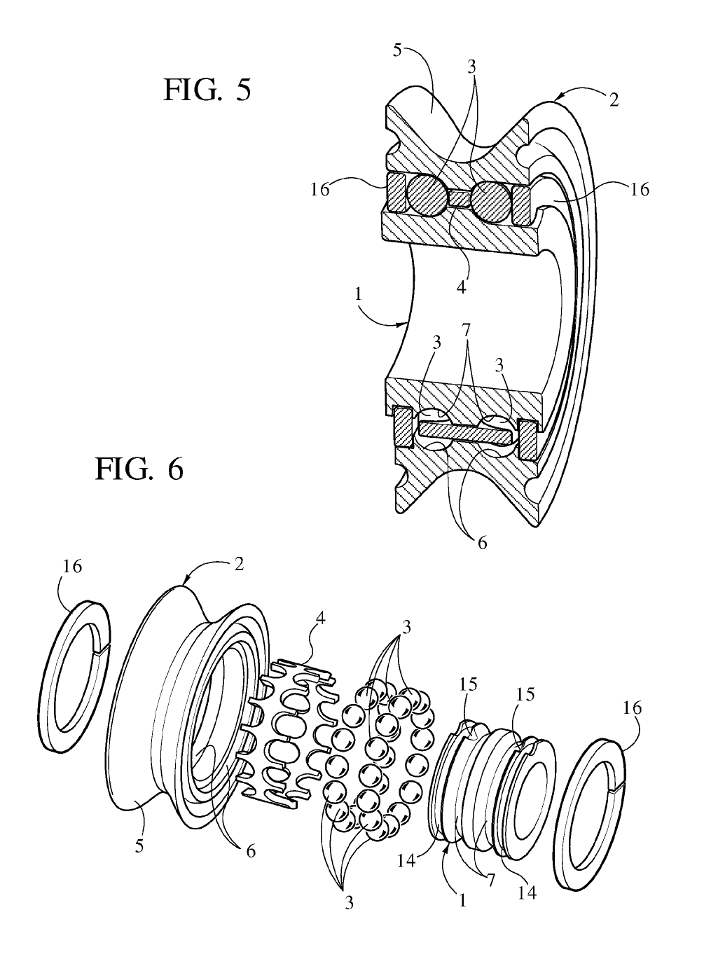

In the case of the variant represented in FIGS. 5 and 6, where the same reference numbers are also used for parts that are similar to the ones already described previously, the internal ring 1 is formed, alongside its races 7, with two lateral annular grooves 14, each of which has respective lowered areas 15 for insertion of the roiling members 3. Each lowered area 15 thus provides also in this case an angular area of localized increase of the radial distance between the races 6 and 7, and for restoring said radial distance there is provided an elastic side ring 16, for example a split ring, inserted at the end of assemblage of the pulley wheel within each side groove 14. The rings 16 also perform a function of protection for the rolling members 3 and for the corresponding races 6, 7 from the effects of external agents.

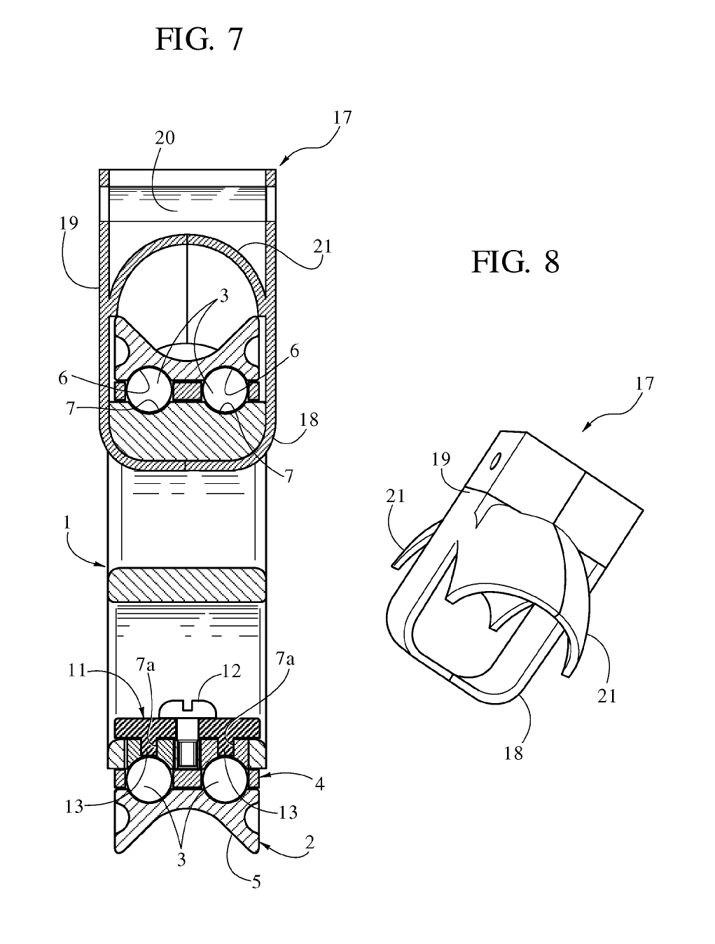

In all the embodiments of the invention, the pulley wheel is normally completed by an attachment element, designated as a whole by 17 in FIGS. 7 and 8, for connection to a strop. The attachment element 17, made up of two parts, comprises a U-shaped band 18 passing underneath the internal ring 1, and a body 19 inserted in the band 18 and having a through hole 20 for the connection to the strop. A pair of curved guards 21 project on opposite sides of the pulley wheel 2 with functions of guide for the sheet or rope fed by the sheave block. The body 19 and the attachment band 18 can, like the ring 1 and the pulley wheel 2, each be made of a single piece or of a number of parts even of different materials.

Of course, the details of construction and the embodiments may vary widely with respect to what is described and illustrated herein, without thereby departing from the scope of the present invention as defined in the ensuing claims.

1. A sheave block comprising,
an internal ring,
an external pulley wheel, which turns coaxially on the internal ring,
rolling means set between the ring and the pulley wheel, and
means of mutual axial retention of the ring and of the pulley wheel,
said means of mutual axial retention comprising mutually facing integral races of the ring and of the pulley wheel in radial-axial contact with said rolling means, and in that the internal ring having at least one angular area of localized increase of the radial distance between said integral races, where there is applied an insert for restoring said radial distance.

2. The sheave block according to claim 1, wherein said insert for restoring the radial distance consists of a double body axially applied to an external radial interruption of the ring.

3. The sheave block according to claim 1, wherein said insert for restoring the radial distance consists of a body applied radially from inside the ring and formed with appendages projecting into respective recesses of the integral races of said ring.

4. The sheave block according to claim 1, wherein said insert for restoring the radial distance consists of a side ring applied within a groove provided alongside the integral race of the ring and formed with a lowered portion.

5. The sheave block according to claim 1, wherein the rolling means comprise at least one annular series of balls or cylindrical rolls or conical rolls or cylindrical rolls with spherical heads, or combinations thereof.

6. The sheave block according to claim 5, wherein the rolling means are associated to a cage.

7. The sheave block according to claim 1, further comprising an attachment element including a band passing through the internal ring and a double guard, which projects on opposite sides of the external pulley wheel.

8. The sheave block according to claim 7, wherein the internal ring, the pulley wheel, the insert for restoring the radial distance, and the attachment element are made of a single material or of a number of materials.

9. A sheave block comprising:
an internal body defining at least one inner race,
an external pulley wheel, which turns coaxially on the internal body and defines at least one outer race facing said at least one inner race,
rolling means set between said at least one inner race and at least one outer race, and
means of mutual axial retention between the internal body and the pulley wheel, comprising said races in radial-axial contact with said rolling means,
the internal body having a radial interruption of the inner race or each inner race at which interruption is set an insert for restoring the radial distance formed by two parts axially applied on opposite sides to said internal body.

10. The sheave block according to claim 9, wherein said two parts consist of a pair of symmetrical and interconnected opposed sectors, the outer surfaces of which complete said races.

11. The sheave block according to claim 9, wherein said two parts consist of a pair of elastic rings inserted within respective lateral annular grooves of said body.

12. The sheave block according to claim 2, wherein the rolling means comprise at least one annular series of balls or cylindrical rolls or conical rolls or cylindrical rolls with spherical heads, or combinations thereof.

13. The sheave block according to claim 3, wherein the rolling means comprise at least one annular series of balls or cylindrical rolls or conical rolls or cylindrical rolls with spherical heads, or combinations thereof.

14. The sheave block according to claim 4, wherein the rolling means comprise at least one annular series of balls or cylindrical rolls or conical rolls or cylindrical rolls with spherical heads, or combinations thereof.

15. The sheave block according to claim 2, further comprising an attachment element including a band passing through the internal ring and a double guard, which projects on opposite sides of the external pulley wheel.

16. The sheave block according to claim 3, further comprising an attachment element including a band passing through the internal ring and a double guard, which projects on opposite sides of the external pulley wheel.

17. The sheave block according to claim 4, further comprising an attachment element including a band passing through the internal ring and a double guard, which projects on opposite sides of the external pulley wheel.

18. The sheave block according to claim 5, further comprising an attachment element including a band passing through the internal ring and a double guard, which projects on opposite sides of the external pulley wheel.

19. The sheave block according to claim 6, further comprising an attachment element including a hand passing through the internal ring and a double guard, which projects on opposite sides of the external pulley wheel.
